(19) United States
(12) Patent Application Publication
(10) Pub. No.: US 2024/0321487 A1
(43) Pub. Date: Sep. 26, 2024

(54) ELECTRONIC COMPONENT

(71) Applicant: Murata Manufacturing Co., Ltd., Nagaokakyo-shi (JP)

(72) Inventors: Tomoya OOSHIMA, Nagaokakyo-shi (JP); Yuuta HOSHINO, Nagaokakyo-shi (JP); Mitsuru NAKANO, Nagaokakyo-shi (JP); Koichi YAMADA, Nagaokakyo-shi (JP); Miki SASAKI, Nagaokakyo-shi (JP)

(21) Appl. No.: 18/671,036

(22) Filed: May 22, 2024

Related U.S. Application Data
(63) Continuation of application No. PCT/JP2023/024303, filed on Jun. 30, 2023.

(30) Foreign Application Priority Data
Aug. 2, 2022 (JP) 2022-123523

(51) Int. Cl. H01C 7/04; H01C 1/14

(52) U.S. Cl. CPC H01C 7/041; H01C 1/1413

(57) ABSTRACT

An electronic component that includes: a base body; a glass film covering at least a part of an outer surface of the base body; and an underlayer electrode covering a part of a surface of the glass film, wherein the base body contains a Mn oxide, the underlayer electrode contains a conductive metal and a glass component, the base body has a reaction layer containing a composite oxide of Mn and the conductive metal at an end portion of the underlayer electrode, and the reaction layer has a void.

### CROSS REFERENCE TO RELATED APPLICATIONS

The present application is a continuation of International application No. PCT/JP2023/024303, filed Jun. 30, 2023, which claims priority to Japanese Patent Application No. 2022-123523, filed Aug. 2, 2022, the entire contents of each of which are incorporated herein by reference.

### TECHNICAL FIELD

The present disclosure relates to an electronic component.

### BACKGROUND ART

The electronic component described in Patent Document 1 includes a base body, a glass film, and an underlayer electrode. The base body is made of ceramics. The glass film covers the outer surface of the base body. The underlayer electrode covers a part of the outer surface of the glass film. The underlayer electrode is electrically connected to an internal electrode in the base body.
Patent Document 1: Japanese Patent No. 6668913

### SUMMARY OF THE DESCRIPTION

In the electronic component as described in Patent Document 1, when an external force is applied to the electronic component, cracks or the like may occur in the glass film. When cracks or the like occur in the glass film, moisture or the like may infiltrate into the base body through the cracks or the like. In particular, in the glass film, cracks or the like are likely to occur in the vicinity of the boundary between the portion covered with the underlayer electrode and the portion not covered therewith.

An electronic component according to an embodiment of the present disclosure includes: a base body; a glass film covering at least a part of an outer surface of the base body; and an underlayer electrode covering a part of an outer surface of the glass film, in which the base body contains a Mn oxide, the underlayer electrode contains a conductive metal and a glass component, the base body has a reaction layer containing a composite oxide of Mn and the conductive metal at a location contacting an end portion of the underlayer electrode, and the reaction layer has a void.

According to the configuration, the base body has a reaction layer, and the reaction layer has a void. When an external force is applied to the electronic component, the void functions as a space that buffers the force. In addition, the reaction layer is located at a site where cracks or the like are likely to occur in the glass film. This makes it possible to prevent the occurrence of cracks or the like in the glass film in the vicinity of the end edge of the underlayer electrode.

It is possible to prevent the occurrence of cracks or the like in the glass film in the vicinity of the boundary between the portion covered with the underlayer electrode and the portion not covered therewith.

### BRIEF EXPLANATION OF THE DRAWINGS

FIG. 1 is a perspective view of an electronic component.

FIG. 2 is a sectional view at the XY-plane passing through the central axis CA in FIG. 1.

FIG. 3 is an enlarged sectional view of the end portion of an underlayer electrode.

FIG. 4 is an enlarged sectional view of the end portion of an underlayer electrode.

FIG. 5 is a flowchart to outline a method of manufacturing an electronic component.

FIG. 6 is an explanatory diagram illustrating a method of manufacturing an electronic component.

FIG. 7 is an explanatory diagram illustrating a method of manufacturing an electronic component.

FIG. 8 is an explanatory diagram illustrating a method of manufacturing an electronic component.

FIG. 9 is an explanatory diagram illustrating a method of manufacturing an electronic component.

FIG. 10 is an explanatory diagram illustrating a method of manufacturing an electronic component.

### DESCRIPTION OF THE PREFERRED EMBODIMENTS

### <Embodiment of Electronic Component>

Hereinafter, an embodiment of the electronic component will be described with reference to the drawings. In the drawings, sometimes a component is illustrated while enlarged for the sake of easy understanding. In some cases, the dimension ratio of a component differs from an actual dimension ratio or a dimension ratio in another drawing.

### (Overall Configuration)

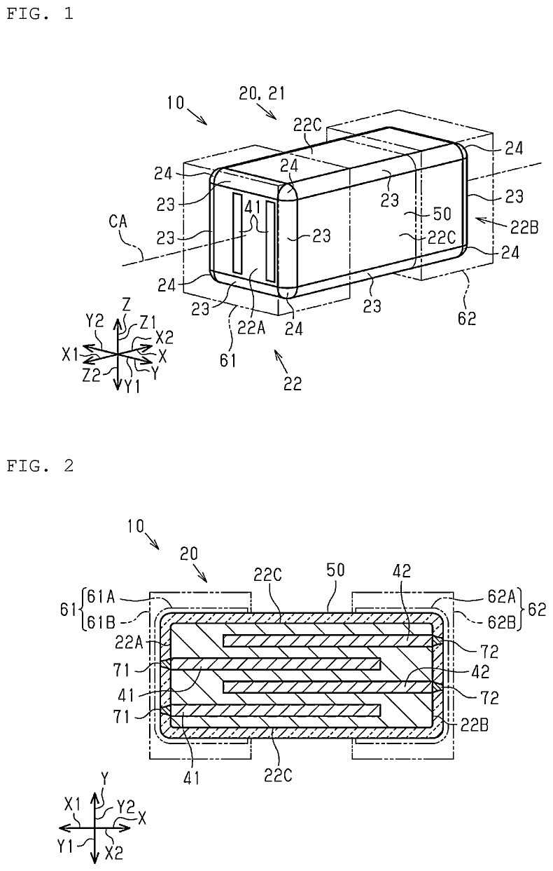

As shown in FIG. 1, an electronic component 10 is, for example, a surface mount negative characteristic thermistor component to be mounted on a circuit board or the like. The negative characteristic thermistor component has a characteristic that the resistance value decreases as the temperature increases.

The electronic component 10 includes a base body 20. The base body 20 has a substantially quadrangular prism shape and has a central axis CA. Hereinafter, the axis extending along the central axis CA is defined as a first axis X. One of the axes orthogonal to the first axis X is defined as a second axis Y. The axis orthogonal to both the first axis X and the second axis Y is defined as a third axis Z. In addition, one of the directions along the first axis X is defined as a first positive direction X1, and the direction opposite to the first positive direction X1 of the directions along the first axis X is defined as a first negative direction X2. One of the directions along the second axis Y is defined as a second positive direction Y1, and the direction opposite to the second positive direction Y1 of the directions along the second axis Y is defined as a second negative direction Y2. In addition, one of the directions along the third axis Z is defined as a third positive direction Z1, and the direction opposite to the third positive direction Z1 of the directions along the third axis Z is defined as a third negative direction Z2.

The outer surface 21 of the base body 20 has six planar surfaces 22. The term “surface” of the base body 20 as used herein refers to a part that can be observed as a surface when the entire base body 20 is observed. That is, for example, if there are minute irregularities or steps that cannot be found unless a part of the base body 20 is enlarged and observed with a microscope or the like, the surface is expressed as a planar surface or a curved surface. The six planar surfaces 22 face in directions different from each other. The six planar surfaces 22 are roughly divided into a first end surface 22A facing the first positive direction X1, a second end surface 22B facing the first negative direction X2, and four side surfaces 22C. The four side surfaces 22C are a surface facing the third positive direction Z1, a surface facing the third negative direction Z2, a surface facing the second positive direction Y1, and a surface facing the second negative direction Y2.

The outer surface 21 of the base body 20 has twelve boundary surfaces 23. The boundary surface 23 includes a curved surface existing at a boundary between the adjacent planar surfaces 22. That is, the boundary surface 23 includes, for example, a curved surface formed by round chamfering a corner formed by adjacent planar surfaces 22.

The outer surface 21 of the base body 20 has eight spherical corner surfaces 24. The corner surface 24 is a boundary part between three adjacent planar surfaces 22. In other words, the corner surface 24 includes a curved surface at a position where three boundary surfaces 23 intersect. That is, the corner surface 24 includes, for example, a curved surface formed by round chamfering a corner formed by three adjacent planar surfaces 22. In FIG. 1, the surface of a glass film 50 to be described later is designated by the same reference numeral as the outer surface 21 of the base body 20.

As illustrated in FIG. 1, in the base body 20, the dimension in the direction along the first axis X is larger than the dimension in the direction along the third axis Z. Furthermore, in the base body 20, the dimension in the direction along the first axis X is larger than the dimension in the direction along the second axis Y. The material of the base body 20 is a ceramic obtained by firing a metal oxide. Specifically, the base body 20 contains one or more selected from Mn₃O₄ and Mn₂NiO₄ as the Mn oxide.

As illustrated in FIG. 2, the electronic component 10 includes two first internal electrodes 41 and two second internal electrodes 42. The first internal electrodes 41 and the second internal electrodes 42 are embedded in the base body 20.

The material of the first internal electrode 41 is a conductive material. For example, the material of the first internal electrode 41 is palladium. The material of the second internal electrode 42 is the same as the material of the first internal electrode 41.

The first internal electrode 41 has a rectangular plate shape. The first internal electrode 41 has a principal surface orthogonal to the second axis Y. The second internal electrode 42 has the same rectangular plate shape as the first internal electrode 41. The second internal electrode 42 has a principal surface orthogonal to the second axis Y, similarly to the first internal electrode 41.

The dimension of the first internal electrode 41 in the direction along the first axis X is smaller than the dimension of the base body 20 in the direction along the first axis X. As illustrated in FIG. 1, the dimension of the first internal electrode 41 in the direction along the third axis Z is approximately ⅔ of the dimension of the base body 20 in the direction along the third axis Z. The dimension of the second internal electrode 42 in each direction is the same as that of the first internal electrode 41.

As illustrated in FIG. 2, the first internal electrodes 41 and the second internal electrodes 42 are located in a staggered manner in the direction along the second axis Y. That is, the first internal electrode 41, the second internal electrode 42, the first internal electrode 41, and the second internal electrode 42 are arranged in this order from the side surface 22C facing the second positive direction Y1 toward the second negative direction Y2. In the embodiment, each of the internal electrodes has an equal distance therebetween in the direction along the second axis Y.

As illustrated in FIG. 1, the two first internal electrodes 41 and the two second internal electrodes 42 are both located at the center of the base body 20 in the direction along the third axis Z. On the other hand, as illustrated in FIG. 2, the first internal electrodes 41 are deviated to the first positive direction X1. The second internal electrodes 42 are deviated to the first negative direction X2.

Specifically, the end of the first internal electrode 41 on the first positive direction X1 side coincides with the end of the base body 20 on the first positive direction X1 side. The end of the first internal electrode 41 on the first negative direction X2 side is located inside the base body 20 and does not reach the end of the base body 20 on the first negative direction X2 side. On the other hand, the end of the second internal electrode 42 on the first negative direction X2 side coincides with the end of the base body 20 on the first negative direction X2 side. The end of the second internal electrode 42 on the first positive direction X1 side is located inside the base body 20 and does not reach the end of the base body 20 on the first positive direction X1 side.

As illustrated in FIG. 2, the electronic component 10 includes a glass film 50. The glass film 50 covers the outer surface 21 of the base body 20. The main material of the glass film 50 is insulating glass. Therefore, the glass film 50 contains silicon dioxide. Note that details of the glass film 50 will be described later.

The electronic component 10 includes a first external electrode 61 and a second external electrode 62. The first external electrode 61 includes a first underlayer electrode 61A and a first metal layer 61B. The first underlayer electrode 61A is stacked on the glass film 50 in a part including the first end surface 22A in the outer surface 21 of the base body 20. Specifically, the first underlayer electrode 61A is a five-surface electrode that covers the first end surface 22A and a part of the four side surfaces 22C on the first positive direction X1 side in the base body 20. The material of the first underlayer electrode 61A is a mixture of a conductive metal and glass. Specifically, the material of the first underlayer electrode 61A is a mixture of Ag and glass.

The first metal layer 61B covers the first underlayer electrode 61A from the outside. Thus, the first metal layer 61B is stacked on the first underlayer electrode 61A. Although not shown in the drawings, the first metal layer 61B has a two-layer structure in which a nickel layer and a tin layer are disposed in order from the first underlayer electrode 61A side.

The second external electrode 62 includes a second underlayer electrode 62A and a second metal layer 62B. The second underlayer electrode 62A is stacked on the glass film 50 in a part including the second end surface 22B in the outer surface 21 of the base body 20. Specifically, the second underlayer electrode 62A is a five-surface electrode that covers the second end surface 22B and a part of the four side surfaces 22C on the first negative direction X2 side in the base body 20. The material of the second underlayer electrode 62A is the same as the material of the first underlayer electrode 61A. That is, the material of the second underlayer electrode 62A is a mixture of Ag and glass.

The second metal layer 62B covers the second underlayer electrode 62A from the outside. Thus, the second metal layer 62B is stacked on the second underlayer electrode 62A. Specifically, similarly to the first metal layer 61B, the second metal layer 62B has a two-layer structure in which a nickel layer and a tin layer are disposed.

The second external electrode 62 does not reach the first external electrode 61 on the side surface 22C, and is disposed away from the first external electrode 61 in the direction along the first axis X. On the side surface 22C of the base body 20, the first external electrode 61 and the second external electrode 62 are not stacked and the glass film 50 is exposed in the central portion in the direction along the first axis X. In FIGS. 1 and 2, the first external electrode 61 and the second external electrode 62 are indicated by two-dot chain lines.

The first external electrode 61 and the end of the first internal electrode 41 on the first positive direction X1 side are connected via a first penetrating portion 71 penetrating the glass film 50. Although details will be described later, the first penetrating portion 71 is formed such that the palladium constituting the first internal electrode 41 extends to the first external electrode 61 side in the manufacturing process of the electronic component 10.

The second external electrode 62 and the end of the second internal electrode 42 on the first negative direction X2 side are connected via a second penetrating portion 72 penetrating the glass film 50. Similarly to the first penetrating portion 71, the second penetrating portion 72 is also formed such that the palladium constituting the second internal electrode 42 extends to the second external electrode 62 side in the manufacturing process of the electronic component 10. In FIG. 2, the first internal electrode 41 and the first penetrating portion 71 are illustrated as separate members having a boundary; however, actually, there is no clear boundary therebetween. In this respect, the same applies to the second penetrating portion 72. In FIG. 1, the first penetrating portion 71 and the second penetrating portion 72 are not shown.

### (Glass Film)

The glass film 50 substantially covers the entire region of the outer surface 21 of the base body 20. Specifically, the glass film 50 covers the entire region of the outer surface 21 of the base body 20 at a location where the first underlayer electrode 61A and the second underlayer electrode 62A are not stacked on the base body 20. On the other hand, the glass film 50 is partly interrupted at a location where the first underlayer electrode 61A and the second underlayer electrode 62A are stacked on the base body 20. In the location where the glass film 50 is interrupted as described above, the first underlayer electrode 61A and the second underlayer electrode 62A are in direct contact with the outer surface 21 of the base body 20. In other words, the first underlayer electrode 61A and the second underlayer electrode 62A cover a part of the glass film 50 and a part of the outer surface 21 of the base body 20 that is not covered with the glass film 50. That is, the first underlayer electrode 61A and the second underlayer electrode 62A cover not only a part of the glass film 50, but also an exposed part of the outer surface 21 of the base body 20 where the glass film 50 is interrupted. For convenience of explanation, FIG. 2 does not illustrate the part where the glass film 50 is interrupted (the part where the first underlayer electrode 61A and the second underlayer electrode 62A cover the outer surface 21 of the base body 20). At the portion not covered with the first underlayer electrode 61A or the second underlayer electrode 62A, the glass film 50 has a thickness TG of 30 nm to 200 nm in the direction perpendicular to the outer surface 21 of the base body 20. The thickness TG of the glass film 50 is an average value of measured values at three different points.

### (Reaction Layer)

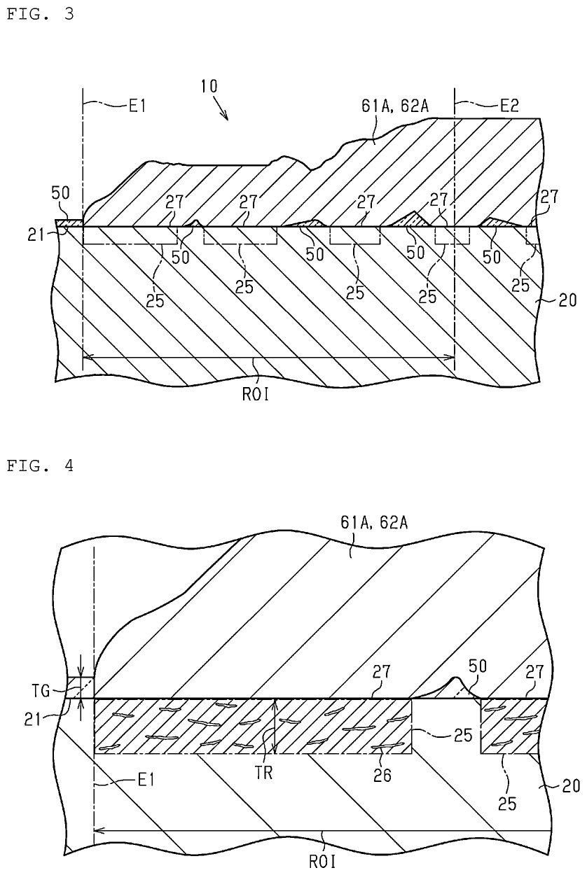

As shown in FIG. 3, the base body 20 has a reaction layer 25. The reaction layer 25 is a part including the outer surface 21 of the base body 20. That is, the outer surface 27 of the reaction layer 25 is a part of the outer surface 21 of the base body 20. The reaction layer 25 contains MnAgO₂, which is a composite oxide of Mn and Ag. In other words, a portion not containing MnAgO₂ in the base body 20 is not the reaction layer 25. The Ag in the composite oxide is derived from the first underlayer electrode 61A and the second underlayer electrode 62A.

The reaction layer 25 is located at a site contacting the first underlayer electrode 61A and the second underlayer electrode 62A in the base body 20. Therefore, the reaction layer 25 also exists at a location contacting the end portion ROI of the first underlayer electrode 61A and the end portion ROI of the second underlayer electrode 62A. FIGS. 3 and 4 illustrate the reaction layer 25 in a quadrangular shape in a sectional view. However, the reaction layer 25 may have an elliptical shape or a polygonal shape other than a quadrangular shape in a sectional view.

The end portion ROI of the first underlayer electrode 61A is defined as follows. First, the electronic component 10 is viewed in a section parallel to the central axis CA. Then, on the section, the total length of the first underlayer electrode 61A in the direction along the central axis CA from the end on the first positive direction X1 side to the end edge E1 on the first negative direction X2 side is specified. The range of the first underlayer electrode 61A from the end edge E1 to the position E2 that is 5% of the total length in the first positive direction X1 is defined as the end portion ROI of the first underlayer electrode 61A. As described above, the end portion ROI of the first underlayer electrode 61A is 5% of the total length in the direction along the central axis CA from the end edge E1. In this respect, the same applies to the second underlayer electrode 62A.

As shown in FIG. 4, the thickness TR of the reaction layer 25 is 50 nm to 500 nm in the direction perpendicular to the outer surface 21 of the base body 20. The thickness TR of the reaction layer 25 is defined as follows. The outer surface 27 of the reaction layer 25 has one arbitrary point, a straight line is drawn from the point in the direction perpendicular to the outer surface 27 of the reaction layer 25 to make an intersection with the surface opposite to the outer surface 27 of the reaction layer 25, and the distance between the one arbitrary point and the intersection is defined as the thickness of the reaction layer 25 at the one arbitrary point. Then, the thickness of the reaction layer 25 is measured at 3 points in one reaction layer 25. The average value of the thicknesses of the reaction layer 25 at the three points is defined as the thickness TR of the entire reaction layer 25.

The reaction layer 25 has a plurality of voids 26. The void 26 has an elongated shape in a specific direction. The direction of the void 26 is substantially along the outer surface 21 of the base body 20. Specifically, when the reaction layer 25 is observed in a section orthogonal to the outer surface 21 of the base body 20, the longest straight line connecting two points on the outer peripheral edge of the void 26 is specified. The straight line makes an acute angle of 0° to 45° against the outer surface 27 of the reaction layer 25.

The ratio of the total volume of the voids 26 with respect to the total volume of the reaction layer 25 is defined as a void ratio. The void ratio is 0.1% to 5%. The void ratio is calculated as follows. First, the section of the end portion ROI of each underlayer electrode and the base body 20 in the vicinity thereof is photographed with an electron microscope. Then, the area of the reaction layer 25 is obtained in the photographed image. Next, the area of the void 26 is obtained in the image. Then, the integrated value of the area of the reaction layer 25 at a position contacting the end portion ROI in the base body 20 is defined as the total volume of the reaction layer 25. Then, the integrated value of the area of the void 26 in each reaction layer 25 is defined as the total volume of the void 26. The void ratio is obtained by multiplying “total volume of void 26/total volume of reaction layer 25” by 100. Therefore, in the present embodiment, the void ratio is expressed in percentage.

### (Method of Manufacturing Electronic Component)

Next, the method of manufacturing the electronic component 10 will be described.

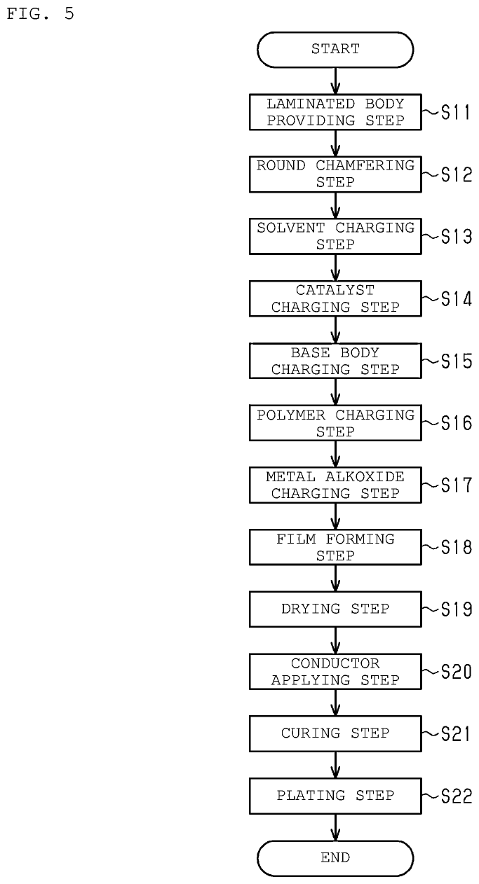

As illustrated in FIG. 5, the method of manufacturing the electronic component 10 includes a laminated body providing step S11, a round chamfering step S12, a solvent charging step S13, a catalyst charging step S14, a base body charging step S15, a polymer charging step S16, and a metal alkoxide charging step S17. The method of manufacturing the electronic component 10 further includes a film forming step S18, a drying step S19, a conductor applying step S20, a curing step S21, and a plating step S22.

First, when the base body 20 is formed, in the laminated body providing step S11, a laminated body that is the base body 20 not having the boundary surfaces 23 or the corner surfaces 24 is provided. That is, the laminated body is in a state before round chamfering, and has a rectangular parallelepiped shape having the six planar surfaces 22. For example, first, a plurality of ceramic sheets to be the base body 20 are provided. Each of the sheets has a thin plate shape. A conductive paste to be the first internal electrode 41 is stacked on the sheet. A ceramic sheet to be the base body 20 is stacked on the stacked paste. A conductive paste to be the second internal electrode 42 is stacked on the sheet. In this manner, the ceramic sheet and the conductive paste are stacked. Then, an unfired laminated body is formed by cutting into a predetermined size. Thereafter, the unfired laminated body is fired at a high temperature to provide a laminated body.

Next, as illustrated in FIG. 5, the round chamfering step S12 is performed. In the round chamfering step S12, the boundary surfaces 23 and the corner surfaces 24 are formed on the laminated body provided in the laminated body providing step S11. For example, a corner of the laminated body is round-chamfered by barrel polishing, whereby the boundary surface 23 having a curved surface and the corner surface 24 having a curved surface are formed. Thus, the base body 20 is formed.

Next, as illustrated in FIG. 5, the solvent charging step S13 is performed. As illustrated in FIG. 6, in the solvent charging step S13, 2-propanol is charged as a solvent 82 into a reaction vessel 81.

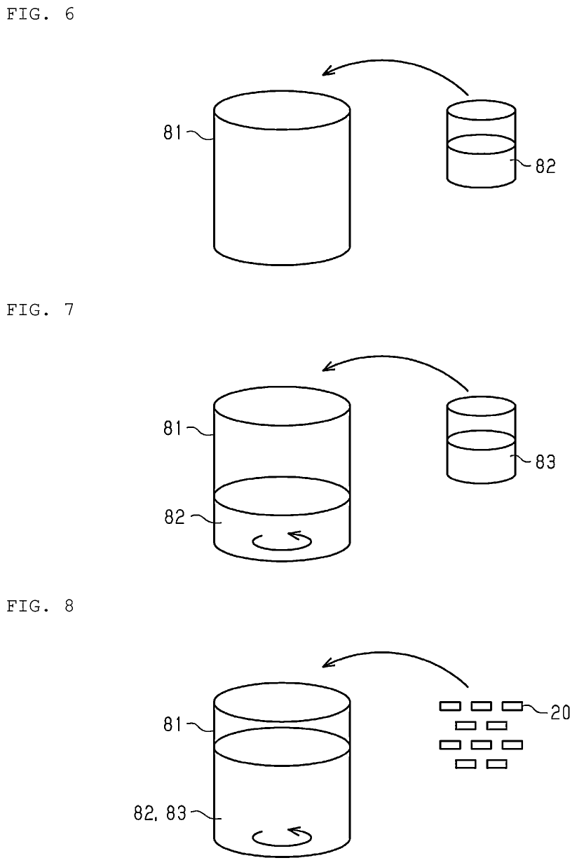

Next, as illustrated in FIG. 5, the catalyst charging step S14 is performed. As illustrated in FIG. 7, in the catalyst charging step S14, first, stirring of the solvent 82 in the reaction vessel 81 is started. Then, ammonia water as an aqueous solution 83 containing a catalyst is charged into the reaction vessel 81. The catalyst in this embodiment is a hydroxide ion, and functions as a catalyst that promotes hydrolysis of a metal alkoxide 85 described later.

Next, as illustrated in FIG. 5, the base body charging step S15 is performed. As illustrated in FIG. 8, in the base body charging step S15, the plurality of base bodies 20 formed in advance in the round chamfering step S12 as described above are charged into the reaction vessel 81.

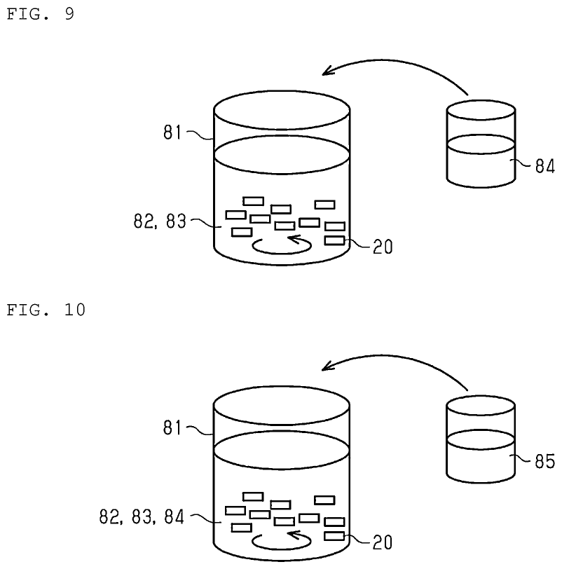

Next, as illustrated in FIG. 5, the polymer charging step S16 is performed. As illustrated in FIG. 9, in the polymer charging step S16, polyvinylpyrrolidone is charged as a polymer 84 into the reaction vessel 81. As a result, the polymer 84 charged into the reaction vessel 81 is adsorbed to the outer surfaces 21 of the base bodies 20.

Next, as illustrated in FIG. 5, the metal alkoxide charging step S17 is performed. As illustrated in FIG. 10, in the metal alkoxide charging step S17, tetraethyl orthosilicate in a liquid state is charged as the metal alkoxide 85 into the reaction vessel 81. Tetraethyl orthosilicate is sometimes referred to as tetraethoxysilane. In the present embodiment, the amount of the metal alkoxide 85 to be charged in the metal alkoxide charging step S17 is calculated based on the area of the outer surface 21 of the base body 20 charged in the base body charging step S15. Specifically, the amount is calculated by multiplying the amount of the metal alkoxide 85 per one base body 20 that is necessary for forming the glass film 50 covering the outer surface 21 of the base body 20 by the number of base bodies 20.

Next, as illustrated in FIG. 5, the film forming step S18 is performed. In the film forming step S18, the stirring of the solvent 82 started in the solvent charging step S13 described above is continued for a predetermined time after the metal alkoxide 85 is charged into the reaction vessel 81 in the metal alkoxide charging step S17.

In the film forming step S18, the glass film 50 is formed by a liquid phase reaction in the reaction vessel 81.

Next, as illustrated in FIG. 5, the drying step S19 is performed. In the drying step S19, after the stirring is continued for the predetermined time in the film forming step S18, the base body 20 is taken out from the reaction vessel 81 and dried. As a result, the sol-like glass film 50 is dried to become a gel-like glass film 50.

Next, as illustrated in FIG. 5, the conductor applying step S20 is performed. In the conductor applying step S20, a conductor paste is applied to two portions of the surface of the glass film 50, that is, a portion including a portion covering the first end surface 22A of the base body 20 and a portion including a portion covering the second end surface 22B of the base body 20. Specifically, the conductor paste is applied to cover the glass film 50 on the entire region of the first end surface 22A and a part of the four side surfaces 22C. Furthermore, the conductor paste is applied to cover the glass film 50 on the entire region of the second end surface 22B and a part of the four side surfaces 22C.

Next, as illustrated in FIG. 5, the curing step S21 is performed. Specifically, in the curing step S21, the glass film 50 and the base body 20 applied with the conductor paste are heated. As a result, water and the polymer 84 are vaporized from the gel-like glass film 50, so that the glass film 50 covering the outer surface 21 of the base body 20 is fired and cured. In the curing step S21, the conductor paste applied in the conductor applying step S20 is fired to form the first underlayer electrode 61A and the second underlayer electrode 62A.

Here, in the glass film 50, a portion in contact with Ag contained in the first underlayer electrode 61A and the second underlayer electrode 62A and a portion in contact with glass contained in the first underlayer electrode 61A and the second underlayer electrode 62A are mixed. When the curing step S21 is performed in this state, the glass film 50 is integrated with the glass contained in the first underlayer electrode 61A and the second underlayer electrode 62A. At this time, the glass film 50 is drawn to the glass contained in the first underlayer electrode 61A and the second underlayer electrode 62A. Therefore, the glass film 50 has unevenness in the thickness TG on the outer surface 21 of the base body 20. Then, Ag contained in the first underlayer electrode 61A and the second underlayer electrode 62A is in direct contact with the base body 20 at some points of the outer surface 21 of the base body 20. Then, Ag diffuses into the base body 20 at a point contacting Ag. As a result, the Mn oxide contained in the base body 20 and Ag react with each other to generate MnAgO₂, a composite oxide. The thus generated MnAgO₂ forms the reaction layer 25.

In addition, the molecular structure of MnAgO₂ contained in the reaction layer 25 has a larger volume per molecular structure than the molecular structures of Mn₃O₄ and Mn₂NiO₄ contained in the base body 20. That is, during the process of generating the reaction layer 25 in the base body 20, the volume of the reaction layer 25 expands and thereby stress is generated in the reaction layer 25. Then, the stress cleaves ionic bonds between the metal atoms and the oxygen atoms in MnAgO₂ of the reaction layer 25. The cleavage of the molecular structure propagates from the cleavage site of the bond as a starting point, thereby forming the void 26 inside the reaction layer 25.

In the present embodiment, at the time of heating in the curing step S21, palladium contained on the first internal electrode 41 side is drawn toward the first underlayer electrode 61A side containing silver due to the Kirkendall effect caused by a difference in diffusion rate between the first internal electrode 41 and the first underlayer electrode 61A. As a result, the first penetrating portion 71 penetrates and extends through the glass film 50 from the first internal electrode 41 toward the first underlayer electrode 61A, so that the first internal electrode 41 and the first underlayer electrode 61A are connected with each other. In this respect, the same applies to the second penetrating portion 72 connecting the second internal electrode 42 and the second underlayer electrode 62A.

Next, as illustrated in FIG. 5, the plating step S22 is performed. Electroplating is performed on portions of the first underlayer electrode 61A and the second underlayer electrode 62A. As a result, the first metal layer 61B is formed on the surface of the first underlayer electrode 61A. In addition, the second metal layer 62B is formed on the surface of the second underlayer electrode 62A. Although not illustrated, the first metal layer 61B and the second metal layer 62B are electroplated with two kinds, nickel and tin, to form a two-layer structure. In this way, the electronic component 10 is formed.

### (Effects of Embodiment)

(1) According to the configuration, the base body 20 has a reaction layer 25, and the reaction layer 25 has a void 26. When an external force is applied to the electronic component 10, the void 26 functions as a space that buffers the force. Moreover, the reaction layer 25 is located at a site where cracks or the like are likely to occur in the glass film 50, that is, in the vicinity of the end portion ROI of each underlayer electrode in the base body 20. This makes it possible to prevent the occurrence of cracks or the like in the glass film 50 in the vicinity of the end portion ROI of the first underlayer electrode 61A and the second underlayer electrode 62A.

(2) According to the embodiment, the first underlayer electrode 61A and the second underlayer electrode 62A contain Ag as a conductive metal, the base body 20 contains one or more Mn oxides selected from Mn₃O₄ and Mn₂NiO₄, and the reaction layer 25 is MnAgO₂. When Ag diffuses into the Mn oxide contained in the base body 20, MnAgO₂ is generated in the Mn oxide. As a result, the molecular structure is changed, and the volume of the reaction layer 25 is increased as compared with that before the reaction. Then, strain is generated in the reaction layer 25, and the bond between Ag and O is cleaved. That is, according to the base body 20, the first underlayer electrode 61A, and the second underlayer electrode 62A having the above composition, the void 26 can be easily provided in the reaction layer 25.

(3) According to the embodiment, the longest straight line connecting two points on the outer peripheral edge of the void 26 makes an acute angle of 0° to 45° against the outer surface 27 of the reaction layer 25. That is, the void 26 extends substantially along the outer surface 27. The stress generated in the outer surface 21 of the base body 20 tends to work in the direction perpendicular to the outer surface 27 of the reaction layer 25. Against a force in such a direction, the void 26 extending along the outer surface 27 has a higher shock absorbing effect. Therefore, the shock on the glass film 50 can be efficiently absorbed.

(4) According to the embodiment, the total volume of the void 26 present in the reaction layer 25 has a ratio of 0.1% to 5% with respect to the total volume of the reaction layer 25. When the void ratio is less than 0.1%, it is difficult to disperse the stress generated in the end portion ROI. Therefore, when stress concentrates on the end portion ROI, cracks or the like are likely to occur in the glass film 50. On the other hand, when the void ratio is larger than 5%, moisture or gas entering the boundary between the base body 20 and the glass film 50 has a wide entry path into the base body 20 for the moisture or gas. That is, the durability of the base body 20 against moisture or gas is likely to decrease. Therefore, with the void ratio of 0.1% to 5%, it is possible to disperse the stress concentrated on the end portion ROI while suppressing a decrease in the durability of the base body 20 against moisture or gas.

(5) According to the embodiment, the reaction layer 25 has a thickness TR of 50 nm to 500 nm. With the reaction layer 25 having a thickness of less than 50 nm, the stress generated in the end portion ROI is less likely to disperse. Therefore, when stress concentrates on the end portion ROI, cracks or the like are likely to occur in the glass film 50. On the other hand, with the reaction layer 25 having a thickness TR of more than 500 nm, moisture or gas entering the boundary between the base body 20 and the glass film 50 is likely to deeply infiltrate into the base body 20. As a result, the durability of the base body 20 is likely to decrease. Therefore, with the reaction layer 25 having a thickness TR of 50 nm to 500 nm, it is possible to disperse the stress concentrated on the end portion ROI while suppressing a decrease in the durability of the base body 20.

(6) According to the embodiment, the glass film 50 has a thickness TG of 30 nm to 200 nm. With the glass film 50 having a thickness TG of less than 30 nm, the conductive metal contained in the first underlayer electrode 61A and the second underlayer electrode 62A is likely to disperse into the base body 20. Therefore, the reaction layer 25 has an increased thickness TR. Accordingly, moisture or gas entering the boundary between the base body 20 and the glass film 50 is likely to deeply infiltrate into the base body 20. As a result, the durability of the base body 20 is likely to decrease. With the glass film 50 having a thickness TG of more than 200 nm, the conductive metal contained in the first underlayer electrode 61A and the second underlayer electrode 62A is less likely to disperse into the base body 20. That is, since the reaction layer 25 has a smaller thickness TR, stress is less likely to disperse. Therefore, when stress concentrates on the end portion ROI, cracks or the like are likely to occur in the glass film 50. Therefore, with the glass film 50 having a thickness TG of 30 nm to 200 nm, the reaction layer 25 having a suitable thickness TR can be formed.

### Other Embodiments

The embodiment can be modified as follows for implementation. The embodiment and the following modifications can be implemented in combination within a range not technically contradictory.

In the embodiment, the electronic component 10 is not limited to a negative characteristic thermistor component. For example, the electronic component may be a thermistor component other than those having a negative characteristic, a multilayer capacitor component, or an inductor component as long as the inside of the base body 20 is provided with some wiring.

The outer surface 21 of the base body 20 does not necessarily have the boundary surface 23 or the corner surface 24. For example, when the boundary between the adjacent planar surfaces 22 of the outer surface 21 of the base body 20 does not have a chamfered shape, there is no curved surface at the boundary. Therefore, in some of such a case, neither the boundary surface 23 nor the corner surface 24 exists.

The base body 20 may contain a Mn oxide other than Mn₃O₄ and Mn₂NiO₄.

In the embodiment, the shapes of the first internal electrode 41 and the second internal electrode 42 are not limited as long as they can ensure electrical conduction with the corresponding first external electrode 61 and second external electrode 62. The number of the first internal electrodes 41 and the number of the second internal electrodes 42 are not limited, and the number of the internal electrodes may be one or may be three or more.

The configuration of the first external electrode 61 is not limited to the example of the embodiment. For example, the first external electrode 61 may include only the first underlayer electrode 61A, or the first metal layer 61B does not necessarily have a two-layer structure. In this respect, the same applies to the second external electrode 62.

In the embodiment, the material combination of the first internal electrode 41 and the first underlayer electrode 61A is not limited to the combination of palladium and silver. For example, a combination of copper and nickel, copper and silver, silver and gold, nickel and cobalt, or nickel and gold may be used. For example, one may be silver, and the other may be a combination of silver and palladium. For example, one may be palladium and the other may be a combination of silver and palladium, or one may be copper and the other may be a combination of silver and palladium. For example, one may be gold, and the other may be a combination of silver and palladium.

In some combinations of the first internal electrode 41 and the first underlayer electrode 61A, the Kirkendall effect cannot be obtained. In this case, the first internal electrode 41 may be processed to be exposed before the external electrode forming step. For example, a part of the glass film 50 may be physically removed by polishing the first end surface 22A side of the base body 20. Thereafter, the first internal electrode 41 and the first underlayer electrode 61A can be connected by performing the underlayer electrode forming step. Alternatively, for example, after the first underlayer electrode 61A is formed, the glass film 50 may be formed on a region including the surface of the first underlayer electrode 61A, and the glass film 50 covering the surface of the first underlayer electrode 61A may be removed. In this respect, the same applies to the material combination of the second internal electrode 42 and the second underlayer electrode 62A.

The arrangement location of the first external electrode 61 is not limited to the example of the embodiment. For example, the first external electrode 61 may be disposed only on the first end surface 22A and one side surface 22C. In this respect, the same applies to the second external electrode 62.

In the embodiment, the conductive metal included in the first underlayer electrode 61A and the second underlayer electrode 62A is not limited to Ag. For example, Au, Cu, or the like may be used. The first underlayer electrode 61A and the second underlayer electrode 62A may contain two or more conductive metals. If the conductive metal contained in the first underlayer electrode 61A and the second underlayer electrode 62A is Cu, the reaction layer 25 contains MnCuO₂ as the composite oxide. Then, the modification makes it possible to obtain the same effect as (2) described above.

Since the first underlayer electrode 61A contains a conductive metal and glass, a part of the first underlayer electrode 61A including the edge may be composed only of glass without containing a metal component. In this case, the glass component contained in the first underlayer electrode 61A and the glass film 50 may be fused so that both do not have a clear boundary. Therefore, when a part of the first underlayer electrode 61A including the edge is composed only of glass without containing a metal component, the end of the metal component of the first underlayer electrode 61A is defined as the end edge E1. In this respect, the same applies to the second underlayer electrode 62A.

In the embodiment, the conductive metals included in the first underlayer electrode 61A and the second underlayer electrode 62A do not have to be the same as each other. For example, the first underlayer electrode 61A may contain Ag, and the second underlayer electrode 62A may contain Cu.

The glass film 50 does not have to cover the entire region of the outer surface 21 of the base body 20, and it is sufficient that the first underlayer electrode 61A and the second underlayer electrode 62A cover the glass film 50. The range covered with the glass film 50 may be appropriately changed in accordance with the shape of the base body 20, the positions of the first external electrode 61 and the second external electrode 62, and the like.

The thickness TG of the glass film 50 in the direction perpendicular to the outer surface 21 of the base body 20 may be less than 30 nm or may be greater than 200 nm.

The reaction layer 25 may contain both MnAgO₂ and MnCuO₂ as the composite oxide, or may contain a composite oxide other than the above.

The thickness TR of the reaction layer 25 in the direction perpendicular to the outer surface 21 of the base body 20 may be less than 50 nm or may be greater than 500 nm.

The total volume of the void 26 present in the reaction layer 25 may have a ratio of less than 0.1% or may have a ratio of more than 5% with respect to the total volume of the reaction layer 25.

The longest straight line connecting two points on the outer peripheral edge of the void 26 may make an acute angle of more than 45° against the outer surface 27 of the reaction layer 25. The shock absorbing effect can be obtained from the void 26 regardless of the extending direction of the void 26.

The ratio of the total volume of the void 26 in the reaction layer 25 with respect to the total volume of the reaction layer 25 is not limited. The shock absorbing effect can be obtained as long as the reaction layer 25 has the void 26.

The technical idea that can be grasped from the embodiment and modifications will be added below.

(1) An electronic component including: a base body; a glass film covering at least a part of an outer surface of the base body; and an underlayer electrode covering a part of an outer surface of the glass film, in which the base body contains a Mn oxide, the underlayer electrode contains a conductive metal and a glass component, the base body has a reaction layer containing a composite oxide of Mn and the conductive metal at a location contacting an end portion of the underlayer electrode, and the reaction layer has a void.

(2) The electronic component according to (1), in which the underlayer electrode contains Ag as the conductive metal, the base body contains one or more selected from Mn₃O₄ and Mn₂NiO₄ as the Mn oxide, and the reaction layer contains MnAgO₂ as the composite oxide.

(3) The electronic component according to (1) or (2), in which the underlayer electrode contains Cu as the conductive metal, the base body contains one or more selected from Mn₃O₄ and Mn₂NiO₄ as the Mn oxide, and the reaction layer contains MnCuO₂ as the composite oxide.

(4) The electronic component according to (1) to (3), in which a longest straight line connecting two points on an outer peripheral edge of the void makes an acute angle of 0° to 45° against an outer surface of the reaction layer.

(5) The electronic component according to (1) to (4), in which a total volume of the void present in the reaction layer has a ratio of 0.1% to 5% with respect to a total volume of the reaction layer.

(6) The electronic component according to (1) to (5), in which the reaction layer has a thickness of 50 nm to 500 nm in a direction perpendicular to the outer surface of the base body.

(7) The electronic component according to (1) to (6), in which the glass film has a thickness of 30 nm to 200 nm in a direction perpendicular to the outer surface of the base body.

### DESCRIPTION OF REFERENCE SYMBOLS

10: Electronic component
20: Base body
21: Outer surface
50: Glass film
25: Reaction layer
26: Void
27: Outer surface
ROI: End portion
TR: Thickness
TG: Thickness

1. An electronic component comprising:
a base body;
a glass film covering at least a part of an outer surface of the base body; and
an underlayer electrode covering a part of an outer surface of the glass film, wherein
the base body contains a Mn oxide,
the underlayer electrode contains a conductive metal and a glass component,
the base body has a reaction layer containing a composite oxide of Mn and the conductive metal at a location contacting an end portion of the underlayer electrode, and
the reaction layer has a void.

2. The electronic component according to claim 1, wherein
the underlayer electrode contains Ag as the conductive metal,
the base body contains one or more selected from Mn₃O₄ and Mn₂NiO₄ as the Mn oxide, and
the reaction layer contains MnAgO₂ as the composite oxide.

3. The electronic component according to claim 1, wherein
the underlayer electrode contains Cu as the conductive metal,
the base body contains one or more selected from Mn₃O₄ and Mn₂NiO₄ as the Mn oxide, and
the reaction layer contains MnCuO₂ as the composite oxide.

4. The electronic component according to claim 1, wherein a longest straight line connecting two points on an outer peripheral edge of the void makes an acute angle of 0° to 45° against an outer surface of the reaction layer.

5. The electronic component according to claim 1, wherein a total volume of the void present in the reaction layer has a ratio of 0.1% to 5% with respect to a total volume of the reaction layer.

6. The electronic component according to claim 1, wherein the reaction layer has a thickness of 50 nm to 500 nm in a direction perpendicular to the outer surface of the base body.

7. The electronic component according to claim 1, wherein the glass film has a thickness of 30 nm to 200 nm in a direction perpendicular to the outer surface of the base body.

8. The electronic component according to claim 1, wherein the conductive metal is selected from Ag, Au, and Cu.

9. The electronic component according to claim 1, wherein the base body contains one or more selected from Mn₃O₄ and Mn₂NiO₄ as the Mn oxide.

10. The electronic component according to claim 1, wherein the reaction layer contains MnAgO₂ as the composite oxide.

11. The electronic component according to claim 1, wherein the reaction layer contains MnCuO₂ as the composite oxide.

12. The electronic component according to claim 1, wherein the reaction layer contains MnAgO₂ and MnCuO₂ as the composite oxide.

13. The electronic component according to claim 1, wherein
the underlayer electrode contains Ag and Cu as the conductive metal,
the base body contains one or more selected from Mn₃O₄ and Mn₂NiO₄ as the Mn oxide, and
the reaction layer contains MnAgO₂ and MnCuO₂ as the composite oxide.
